(19) United States
(12) Patent Application Publication
(10) Pub. No.: US 2009/0074219 A1
(43) Pub. Date: Mar. 19, 2009

(54) Hearing Aid

(75) Inventors: Harald Klemenz, Singapore (SG); Eng Cheong Lim, Singapore (SG); Daniel Reisse, Erlangen (DE)

Correspondence Address: LERNER GREENBERG STEMER LLP, P O BOX 2480, HOLLYWOOD, FL, 33022-2480, US

(73) Assignee: SIEMENS MEDICAL INSTRUMENTS PTE, LTD., Singapore (SG)

(21) Appl. No.: 12/211,847

(22) Filed: Sep. 17, 2008

(30) Foreign Application Priority Data
Sep. 17, 2007 (DE) 10 2007 044 205.1

(51) Int. Cl. H04R 25/00

(52) U.S. Cl. 381/324; 381/322

(57) ABSTRACT

A hearing aid has a housing, in which an electrical heating device is disposed in the housing. Because of the electrical heating device, moisture that occurs inside of the housing can be removed from the housing in a simple way, irrespective of whether a watertight hearing aid or an open system is concerned.

### CROSS-REFERENCE TO RELATED APPLICATION

This application claims the priority, under 35 U.S.C. §119, of German application DE 10 2007 044 205.1, filed Sep. 17, 2007; the prior application is herewith incorporated by reference in its entirety.

### BACKGROUND OF THE INVENTION

1. Field of the Invention

The invention relates to a hearing aid with a housing. Hearing aids are sensitive, micromechanical devices that contain a large number of components. To protect this large number of components from external environment influences and join them together to form a device, the hearing aid is surrounded by a housing.

This gives rise to the problem that moisture often collects inside the housing. This moisture may either penetrate into the device from the outside or form as condensed water, which collects in the housing and impairs the function of the sensitive electrical and mechanical components. To solve this problem, it is known to keep the hearing aid in a drying bag or a drying station for certain periods of time, for example overnight. If the housing is not of a completely watertight configuration, the moisture can escape through small openings and gaps in the housing and be absorbed by the drying agent.

However, completely watertight hearing systems are also common. They are more reliable, because the penetration of moisture is made more difficult. If moisture nevertheless penetrates into such a watertight hearing aid, it can no longer escape even when it is stored in a drying bag. As a result, the function of the hearing aid is impaired and the service life is shortened.

A transporting and storing box for hearing aids is known from the German utility model DE 20 2005 002402 U1. It contains a reclosable container. The container has wall elements that enclose a storage compartment for hearing aids. An electrical resistance heater formed as a sheet-like heating foil and arranged on one of the wall elements is provided in the container.

A drying pad for drying and storing hearing aids and otoplasties is known from German utility model DE 299 17 447 U1. The drying pad has two layers lying loosely one on top of the other, which are joined to one another around their edge and form an envelope. At least one of the layers is provided with spaced-apart perforations. A double-ply sheet produced from plasticized polyvinyl chloride, in which the heating elements and a protective conductor are incorporated, is fitted between the layers.

### SUMMARY OF THE INVENTION

It is accordingly an object of the invention to provide a hearing aid that overcomes the above-mentioned disadvantages of the prior art devices of this general type, with which moisture that occurs can be removed from the housing in a simple way, irrespective of whether a watertight hearing aid or an open system is concerned.

The object is achieved according to the invention by a hearing aid with a housing in which an electrical heating device is disposed in the housing.

According to the invention, it has been recognized that moisture entering can be removed from the housing of a hearing aid in a particularly simple way by a heating element being fitted inside. The increased temperature inside the housing has the effect that moisture that has occurred is transformed into a gaseous state of aggregation. This can subsequently escape through at least one opening in the housing of the hearing aid. The housing will often have a gap in any case, for example at the joining between two housing parts. If it is a hearing aid housing of a configuration that is completely watertight during operation, the housing may be provided with a closable opening, which is open during the operation of the heating element to allow the moist-warm air to escape.

For the short-term operation of the heating element, the electrical energy store that is present in any case in hearing aids to operate the amplifier electronics is available. The energy store may be an electrochemical element, for example a lithium-polymer storage battery or a high-capacitance capacitor.

In the hearing aid there is usually a device to recharge the electrical energy store in the fitted state. In this case, the heating device can be operated at the charging times of the energy store. As a result, the heating device is independent of the limited energy supply of the built-in energy store.

If the energy store in the hearing aid is to be recharged, the hearing aid is provided with a connection device, which makes it possible to connect an electrical energy source disposed outside the housing to components inside the hearing aid. Such an energy transfer into the housing may take place, for example, capacitively. In this case, a conductive plate that acts as a plate of a plate capacitor is fitted inside the housing. The charger has a second, corresponding plate, which lies opposite the first plate, fitted in the hearing aid, when the hearing aid is inserted in the charger. Applying an alternating voltage to the plate in the charger allows an alternating current to flow through the electrically non-conducting housing.

In a similar way, an inductive energy transfer may also take place through a transmitter coil in the charger and a receiver coil in the hearing aid. An oscillating electric field in the transmitter coil induces an alternating current in the receiver coil. After rectification and smoothing, this is available for supplying the charging and heating operation. These contactless processes have the advantage that the housing does not have to be opened for electrical contact to be made. The water tightness is retained as a result. In the case of an inductive energy transfer, the receiver coil may also be used as a heating device, by the lost power of the coil being used for heating the hearing aid.

As a third alternative, however, it is also possible for electrical contact to be made by at least two galvanic contacts. These consist of an electrically conductive material, for example a metal or an alloy. A first partial area of the contact is incorporated in the outer wall of the housing in such a way that it is accessible from the outside. A second partial area extends into the interior of the housing, so that a closed circuit can be set up from the outside to the inside. If a liquid-tight hearing aid is required, a seal may be provided at the boundary surfaces of the contacts with the housing.

Since the charger for recharging the electrical energy store in the hearing aid is only subject to minor size restrictions, there is an abundance of electrical energy available inside the hearing aid as long as the hearing aid is connected to the charger. It is therefore particularly advantageous for the heating device only to be operated when the hearing aid is connected to the charger. If the hearing aid is fixed in the charger by a mechanical mount, the latter can be used at the same time to actuate a vent in the hearing aid of an otherwise watertight configuration by use of an actuating device. The necessary closing force of such a vent may be applied, for example, by spring force. The opening force that opposes the closing force to open the vent may then be applied either mechanically or magnetically by the charger.

A particularly reliable configuration of a watertight hearing aid is obtained in particular when no vent is provided. In order to transport the moisture transformed into the gaseous state of aggregation by the heating device according to the invention out of the housing, it is appropriate in such a case to produce the housing at least partially from a material that is impermeable to liquid water, but permeable to gaseous water. Such a material is, for example, expanded polytetrafluoroethylene.

In one embodiment of the invention, the electrical energy store is separated from the charging contacts specifically when the hearing aid is not inserted in a charger. This achieves the effect that there is no voltage at the charging contacts while the hearing aid is being worn by the user. As a result, the risk of short-circuits is minimized. Furthermore, in this case the heating device can remain permanently connected to the charging contacts. Since the charging contacts have no contact with the electrical energy store, the latter will not be discharged. When the hearing aid is inserted into an associated charger, however, the heating device is automatically turned on without any action on the part of the user and at the same time the electrical energy store is recharged.

In a further embodiment, a plurality of electrical contacts may also be present on the housing of the hearing aid. This allows separate circuits to be provided for the heating device and the charging contacts of the electrical energy store. This makes it possible for the user to decide himself, for example by a selection device on the charger, whether the hearing aid is to be dried by additional supplementary heating or whether only charging of the electrical energy store is to be performed. As a result, undesired heating up, which reduces wearing comfort, can be avoided.

The heating device itself may be formed as a conductor loop. The heating output can be adapted exactly to the respective heat requirement by choice of the electrical resistance of the loop and the current flowing through the loop. The conductor loop may be spatially arranged in the region in which it has been found from experience that condensed water is most likely to collect. Consequently, the heating output can have a spatially inhomogeneous distribution over the volume of the housing.

A particularly space-saving configuration of the heating device is obtained if it is formed as an electrically conductive coating. For example, the inside of the hearing aid housing is provided with a coating. It goes without saying, however, that it is also possible for other components, for example the component side of the printed circuit board, to be provided with an electrically conductive coating that can be used as a heating device. The layer itself may, for example, consist of a metal or an alloy or of carbon. The resistivity of the material used, the layer thickness and the heated surface area in this case determine the electrical resistance of the heating device and the maximum current handling capacity. Consequently, the maximum heating output is also fixed by these parameters. From case to case, the heating output can be made higher in some spatial regions and lower in other spatial regions by structuring of the layer.

In order to supply the electrical heating device with electrical energy, it may be provided in one embodiment of the invention to induce eddy currents in an electrically conductive coating inside the housing by a magnetic field. The eddy currents are in the same way subject to an ohmic loss, so that this lost power is converted into heat.

Other features which are considered as characteristic for the invention are set forth in the appended claims.

Although the invention is illustrated and described herein as embodied in a hearing aid, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, cross-sectional view through a hearing aid according to the invention; and

FIG. 2 is an illustration of a further embodiment, in which a housing of the hearing aid is produced from a hard material, i.e. a material that cannot be deformed.

### DETAILED DESCRIPTION OF THE INVENTION

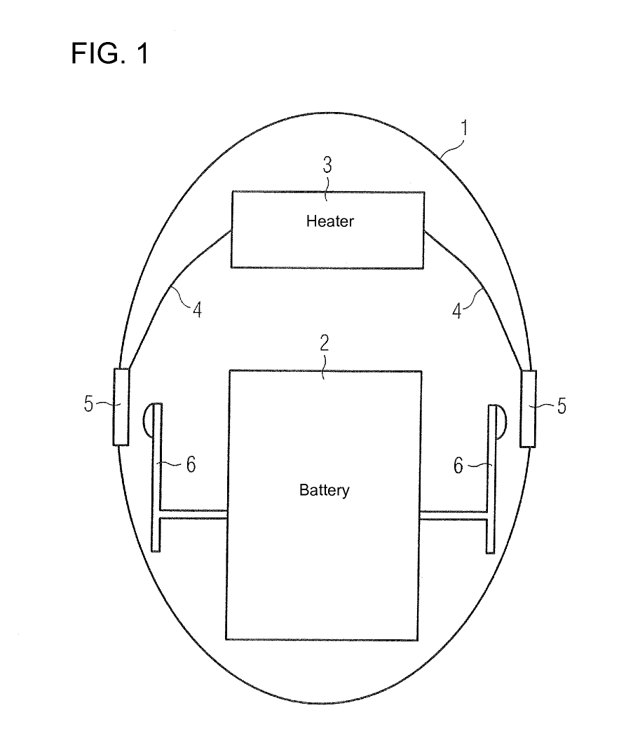

Referring now to the figures of the drawing in detail and first, particularly, to FIG. 1 thereof, there is shown a cross section through a hearing aid. The outer delimitations of the hearing aid is formed by a housing 1. The housing 1 has in the example an oval cross section at the location considered. Inside the housing there is an electrical energy store, for example a storage battery 2, and an electrical heating device 3. Recessed in the housing wall are electrical contacts 5, by which an external voltage source can be connected to the devices inside the housing. For this purpose, the electrically conductive contacts 5 are recessed in the housing wall 1 in such a way that a first surface of the contact is accessible from the outside and a second, opposed surface of the contact elements 5 is on the inner side.

The storage battery 2 is permanently connected to non-illustrated amplifier electronics of the hearing aid. From case to case, this may take place by a switch, so that the user can turn his hearing aid off when it is not required. Furthermore, both contacts of the storage battery 2 are provided with charging contacts 6. These are arranged at a distance from the inner surface areas of the outer connection contacts 5. As a result, the connection contacts 5 are voltage-free during the operation of the hearing aid.

The heating device 3 is permanently connected to the outer connection contacts 5 by connection lines 4. Since the outer connection contacts 5 are not in connection with the storage battery contacts 6, no current flows through the heating element 3 during normal operation of the hearing aid.

The charger belonging to the hearing aid has a receiving compartment, which has a width that is slightly smaller than the shorter axis of symmetry of the elliptical cross section 1. The housing of the hearing aid 1 is produced from elastic material, so that it is compressed along the short axis of symmetry when it is inserted into the charging compartment. The deformation is in this case so great that the outer connection contacts 5 are in engagement with the charging contacts 6. The charger is so configured that, in this position, the contacts of the charger 6 are in engagement with the outer surface areas of the connection contacts 5. As a result, the current of the charger is conducted through the contact 5, both to the charging contact 6 and to the energy store 2, and also through the heating element 3. Consequently, excess moisture is removed from the inside of the hearing aid housing 1 during the charging cycle of the energy store 2.

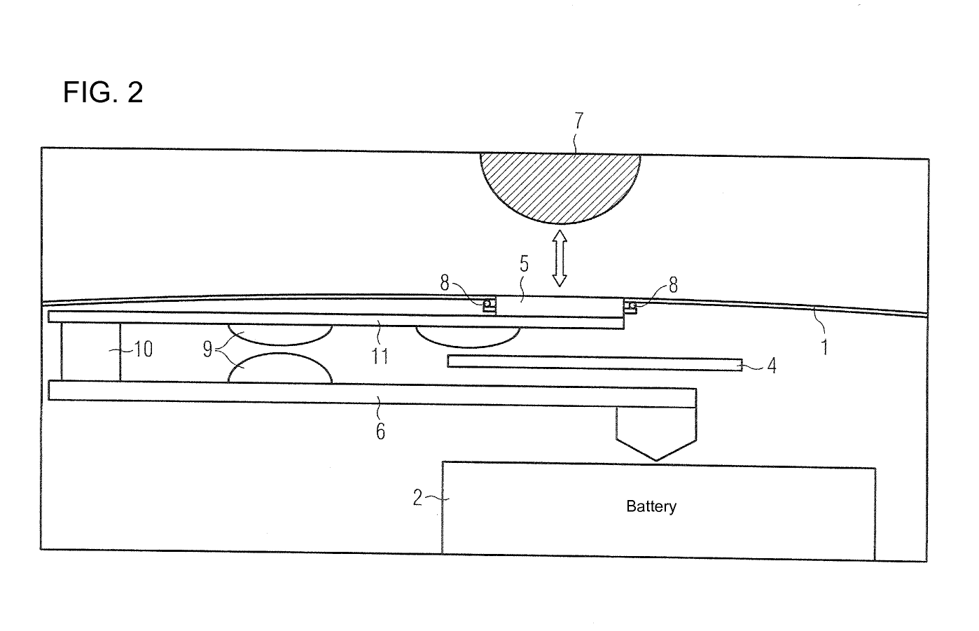

FIG. 2 shows a further embodiment, in which the housing 1 of the hearing aid is produced from a hard material, i.e. a material that cannot be deformed. A cross section through the region of the housing wall in which a contact of an external power supply device is arranged is represented. In order to achieve a closed circuit, the arrangement represented in FIG. 2 is present at least twice in the hearing aid.

A detail of the electrical energy store 2 is represented in the lower region of the FIG. 2. This is once again provided with a charging contact 6. In the housing wall 1 there is a bore, in which the outer charging connection 5 is displaceably mounted. The direction of movement in this case runs substantially orthogonally in relation to the outer surface area of the housing wall 1. The outer connection contact 5 is mounted by a leaf spring in such a way that, in the absence of an external force acting on the connection contact 5, the spring closes the housing opening by an O-ring. An insulator 10 represents an insulating holder for the charging contact 6 and the connection contact 5. Two contact elements 9 are arranged on a leaf spring 11 of the connection contact 5.

A further contact element 9 is located on the charging contact 6 of the energy store. Disposed between the connection contact 5 and the charging contact 6 is a connection element 4, which is in electrically conductive connection with the heating element. The heating element itself is not represented in FIG. 2 for reasons of overall clarity.

If the user then establishes a connection of the outer connection contact 5 with a contact 7 of a charger, the contact 5 on its leaf spring is pressed into the interior of the housing. As a result, the contact elements 9 represent a conducting connection from the connection contact 5 by way of the leaf spring 11 and the contact elements 9 to the charging contact 6. Consequently, a charging current flows into the electrical energy store 2. The same movement produces the effect that the leaf spring 11 makes physical contact with the second contact element 9 and the connection element 4. Consequently, a current likewise flows from the contact 7 of the charger by way of the connection contact 5 and the connection element 4 to the heating resistance 3. The inward movement of the connection contact 5 has the effect that the pressing pressure of the O-ring seal 8 that is produced by the leaf spring against the housing wall 1 is discontinued. As a result, the moisture that has become gaseous under the effect of the heating element 3 can escape through the gap between the housing wall 1 and the connection contact 5.

During the operation of the hearing aid, the contact 7 of the charger is lifted off from the connection contact 5. The absent externally acting counterforce has the effect that the leaf spring 11 moves the connection contact 5 outward in its opening of the housing. As a result, the opening is again closed in a watertight manner by the connection contact 5 and the O-ring seal 8. In this way, penetration of moisture into the interior of the housing of the hearing aid is made more difficult.

Since moisture and condensed water entering are removed from the interior of the device by the heating element 3 with every charging cycle of the energy store 2, there is a decrease in the susceptibility for repair of the hearing aid. As a result, the operational reliability is desirably increased.

1. A hearing aid, comprising:
a housing; and
an electrical heating device disposed in said housing.

2. The hearing aid according to claim 1, wherein said housing is protected from penetrating moisture.

3. The hearing aid according to claim 1, further comprising a connection device for connecting an electrical energy source disposed outside said housing to components inside the hearing aid.

4. The hearing aid according to claim 3, wherein said connection device contains at least two galvanic contacts.

5. The hearing aid according to claim 3, further comprising an electrical energy store disposed in said housing and said connection device is provided for charging said electrical energy store.

6. The hearing aid according to claim 5, wherein said connection device is formed such that said connection device can be disconnected from said electrical energy store.

7. The hearing aid according to claim 3, wherein said connection device provided for supplying said electrical heating device with electrical energy.

8. The hearing aid according to claim 2, wherein said housing has a housing wall with a closable opening formed therein.

9. The hearing aid according to claim 8, further comprising means for opening said closable opening during an operation of said electrical heating device.

10. The hearing aid according to claim 1, wherein said electrical heating device has an ohmic resistance heater.

11. The hearing aid according to claim 10, wherein said housing has a housing wall and said electrical heating device is formed at least as a partial coating of said housing wall.

12. The hearing aid according to claim 11, wherein said partial coating has a thickness of approximately 1 μm to approximately 50 μm.
